(19) United States
(12) Patent Application Publication
(10) Pub. No.: US 2017/0291571 A1
(43) Pub. Date: Oct. 12, 2017

(54) WEBBING TAKE-UP DEVICE

(71) Applicant: KABUSHIKI KAISHA TOKAI-RIKA-DENKI-SEISAKUSHO, Aichi-ken (JP)

(72) Inventors: Hitoshi TAKAMATSU, Aichi-ken (JP); Keita NAKANE, Aichi-ken (JP)

(21) Appl. No.: 15/475,840

(22) Filed: Mar. 31, 2017

(30) Foreign Application Priority Data
Apr. 11, 2016 (JP) 2016-078984

(51) Int. Cl. B60R 22/44

(52) U.S. Cl. CPC B60R 22/44

(57) ABSTRACT

In a webbing take-up device, in a state in which a stopper of a force limiter stopper mechanism has been brought into abutting contact with a stopper abutment portion resulting in rotation of a spool in a pull-out direction having become limited, the stopper is disposed on the inside of a flywheel hole portion of a flywheel body of a flywheel of a second force limiter mechanism. For this reason, deformation of the stopper outward in its radial direction can be suppressed by the flywheel body of the flywheel.

### CROSS-REFERENCE TO RELATED APPLICATION

This application claims priority under 35 USC 119 from Japanese Patent Application No. 2016-078984 filed on Apr. 11, 2016, the disclosure of which is incorporated by reference herein.

### BACKGROUND

### Field of the Invention

The present invention relates to a webbing take-up device in which rotation of a spool in a pull-out direction with respect to a lock base is limited by a limiting member.

### Related Art

There is a webbing take-up device in which, at the time of a vehicle emergency, a spool is rotated in a pull-out direction with respect to a lock base in a state in which rotation of the lock base in the pull-out direction has been limited, and due thereto, a torsion bar connecting the spool and the lock base becomes torsionally deformed (for one example, see Japanese Patent Application Laid-open (JP-A) No. 2012-030636).

In this type of webbing take-up device, a stopper is provided on the lock base-side section of the inside of the spool. A through hole having female threads is formed in the stopper, and the female threads of the stopper are screwed together with male threads formed on the lock base. When the stopper is rotated together with the spool in the pull-out direction with respect to the lock base, the stopper is guided by the male threads of the lock base and moves closer to the lock base. When the spool rotates a certain amount with respect to the lock base, the stopper is brought into abutting contact with the lock base, and due thereto, the rotation of the spool in the pull-out direction is limited.

In this configuration, when the stopper has come into abutting contact with the lock base, a force that causes the female threads of the stopper to separate from the male threads of the lock base acts on the female threads of the stopper due to the rotational force of the stopper in the pull-out direction. In order to suppress deformation of the stopper caused by this force, the mechanical strength of the spool has been increased.

### SUMMARY

In view of the circumstance described above, a webbing take-up device that is no need to increase mechanical strength of a spool and a lock rotor for the purpose of suppressing deformation of a limiting member outward in its radial direction is obtained.

A webbing take-up device of a first aspect includes: a spool that is rotated in a pull-out direction due to webbing being pulled out therefrom; a lock rotor whose rotation is limited at a time of a vehicle emergency; a limiting (restricting) member that is rotated and also moved in a direction of an axis of rotation due to the spool being rotated in the pull-out direction in a rotation-limited state of the lock rotor, and that limits (restricts) rotation of the spool in the pull-out direction due to movement of the limiting member in the direction of the axis of rotation being limited; and a deformation suppressing (controlling) member that is provided separately from the spool and the lock rotor, and that suppresses (controls), from an outer side of the limiting member in a radial direction of the limiting member, deformation of the limiting member toward the outer side in the radial direction in a state in which movement of the limiting member in the direction of the axis of rotation is limited.

According to the webbing take-up device of the first aspect, when the limiting member is going to (try to) become deformed outward in its radial direction in a state in which movement of the limiting member in the direction of its axis of rotation has been limited, the deformation of the limiting member is suppressed by the deformation suppressing member which is provided separately from the spool and the lock rotor (which is an independent and different member from the spool and the lock rotor).

For this reason, because the deformation of the limiting member outward in its radial direction can be suppressed by the deformation suppressing member, the need to increase the mechanical strength of the spool or the lock rotor for the purpose of suppressing the deformation of the limiting member outward in its radial direction can be eliminated.

A webbing take-up device of a second aspect of the invention is the webbing take-up device of the first aspect, wherein the deformation suppressing member is rotatable by receiving rotational force.

According to the webbing take-up device of the second aspect, the deformation suppressing member can rotate when it receives rotational force. For this reason, a member that is rotated when it receives rotational force for a purpose other than suppressing deformation of the limiting member can be made to function as the deformation suppressing member. Due thereto, the number of parts can be suppressed from increasing just for the purpose of suppressing deformation of the limiting member.

A webbing take-up device of a third aspect of the invention is the webbing take-up device of the second aspect, wherein the deformation suppressing member is rotatable by rotational force of the spool being transmitted thereto and is configured to absorb, by means of inertial force of the deformation suppressing member, the rotational force of the spool.

According to the webbing take-up device of the third aspect, the deformation suppressing member can absorb, by means of its inertial force, the rotational force from the spool. Here, in a configuration where the rotational force of the spool is absorbed by inertial force, the mass of the member for generating the inertial force is set large, so the mechanical strength of the member for generating the inertial force also becomes relatively large. For this reason, it is not necessary to provide a part whose mass and mechanical strength are large just for the purpose of suppressing deformation of the limiting member, and the mass of the device overall can be suppressed from increasing.

A webbing take-up device of a fourth aspect of the invention is the webbing take-up device of the second aspect or the third aspect, wherein the deformation suppressing member is disposed coaxially with respect to the limiting member, at least part of the limiting member is disposed inside the deformation suppressing member in a state in which movement of the limiting member in the direction of the axis of rotation is limited, and the deformation suppressing member suppresses deformation of the limiting member from the outer side in the radial direction of the limiting member.

According to the webbing take-up device of the fourth aspect, the deformation suppressing member is disposed coaxially with respect to the limiting member, and has at least part of the limiting member disposed inside in a state in which movement of the limiting member in the direction of its axis of rotation has been limited. Deformation of the limiting member is suppressed by the deformation suppressing member from the radial direction outer side of the limiting member.

Here, the deformation suppressing member is disposed coaxially with respect to the limiting member and has at least part of the limiting member disposed inside in a state in which movement of the limiting member in the direction of its axis of rotation has been limited. For this reason, the configuration for limiting rotation of the spool in the pull-out direction by means of the limiting member and the rotating mechanism configured to include the deformation suppressing member overlap each other (lie on top of each other) in a direction orthogonal to the axis of rotation of the limiting member. Due thereto, the device can be suppressed from increasing in size.

In the webbing take-up device of the above aspects, a hole portion is formed at the deformation suppressing member at a center portion of the deformation suppressing member, and at least part of the limiting member is disposed inside the hole portion in a state in which the limiting member abuts the lock rotor.

As described above, the webbing take-up device of the aspects can eliminate the need to increase the mechanical strength of the spool and the lock rotor for the purpose of suppressing deformation of the limiting member outward in its radial direction.

### BRIEF DESCRIPTION OF THE DRAWINGS

An exemplary embodiment will be described in detail with reference to the following figures, wherein:

FIG. 1 is a front sectional view of a second force limiter mechanism and a force limiter stopper mechanism of a webbing take-up device pertaining to the exemplary embodiment;

FIG. 2 is a front sectional view, corresponding to FIG. 1, showing a state in which movement of a stopper of the force limiter stopper mechanism in the direction of its axis of rotation has been limited;

FIG. 3 is a perspective view of the webbing take-up device pertaining to the exemplary embodiment; and

FIG. 4 is an exploded perspective view of the second force limiter mechanism and the force limiter stopper mechanism of the webbing take-up device pertaining to the exemplary embodiment.

### DETAILED DESCRIPTION

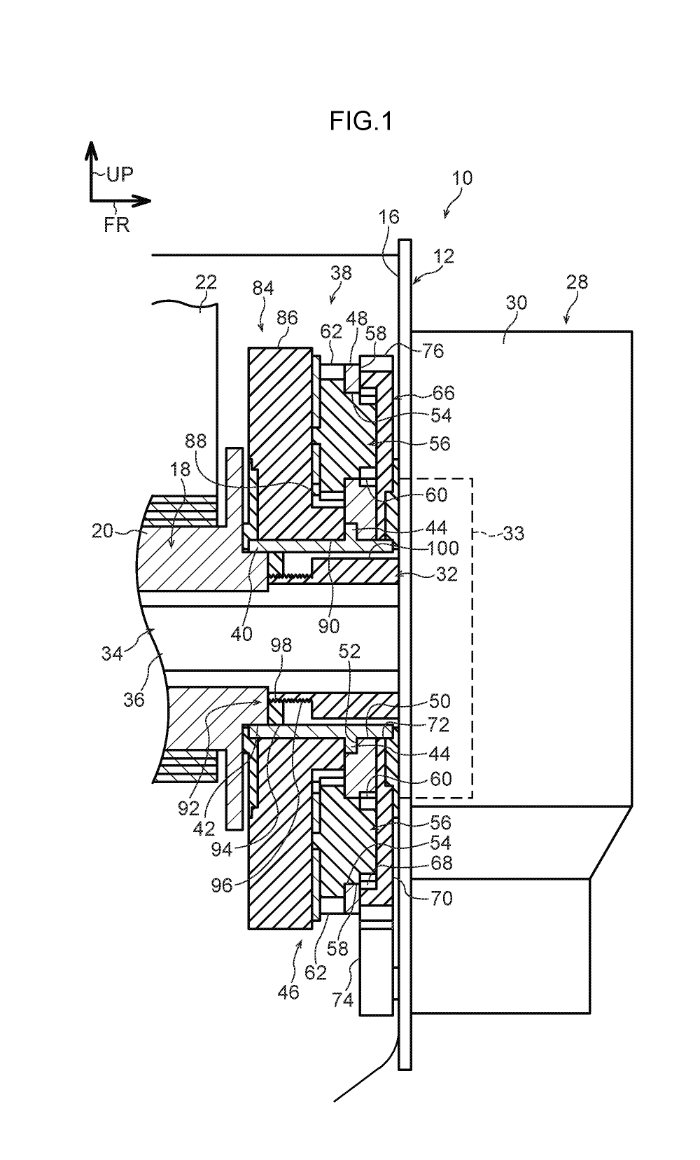

An exemplary embodiment will be described on the basis of FIG. 1 to FIG. 4. It should be noted in regard to the drawings that arrow FR indicates a forward direction of a vehicle to which a webbing take-up device 10 has been applied, arrow OUT indicates an outward direction in the vehicle width direction, and arrow UP indicates the vehicle upward direction.

<Configuration of Exemplary Embodiment>

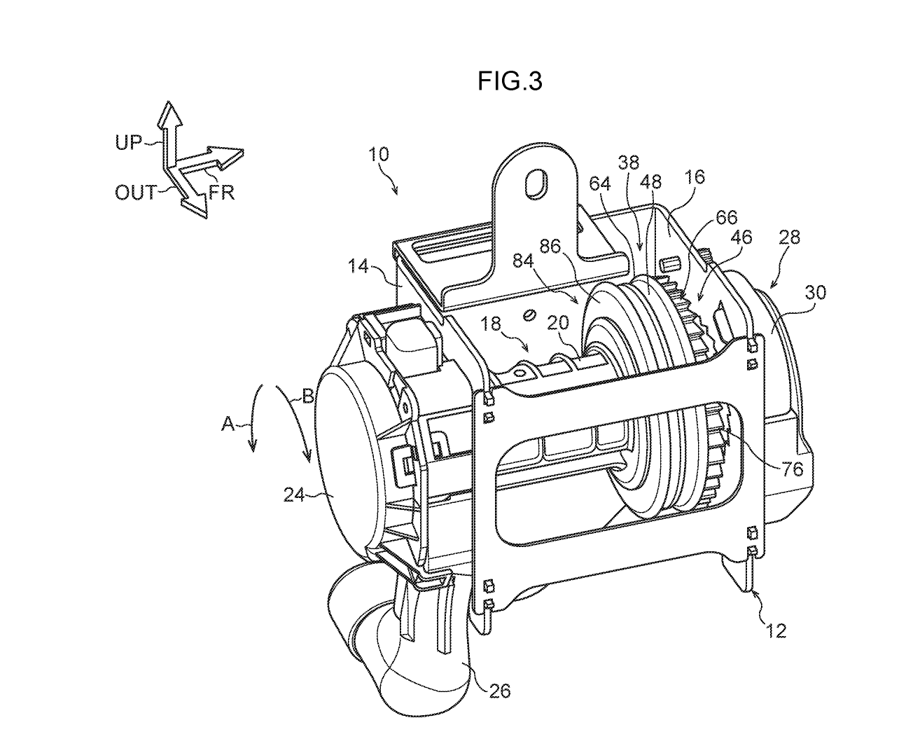

As shown in FIG. 3, the webbing take-up device 10 pertaining to the present exemplary embodiment is equipped with a frame 12. The frame 12 is fixed to the vehicle lower side section of a center pillar (not shown in the drawings) serving as a vehicle body of the vehicle. Furthermore, the frame 12 is equipped with leg plates 14 and 16, and the leg plate 14 and the leg plate 16 oppose each other in the substantially vehicle front and rear direction.

Furthermore, the webbing take-up device 10 is equipped with a spool 18, and the spool 18 is equipped with a spool body 20. The spool body 20 is formed in a substantially cylinder (tube) shape and is disposed between the leg plate 14 and the leg plate 16 of the frame 12. The direction of the central axis of the spool body 20 lies along the direction in which the leg plate 14 and the leg plate 16 oppose each other (that is, the substantially vehicle front and rear direction), and the spool body 20 is rotatable about its central axis.

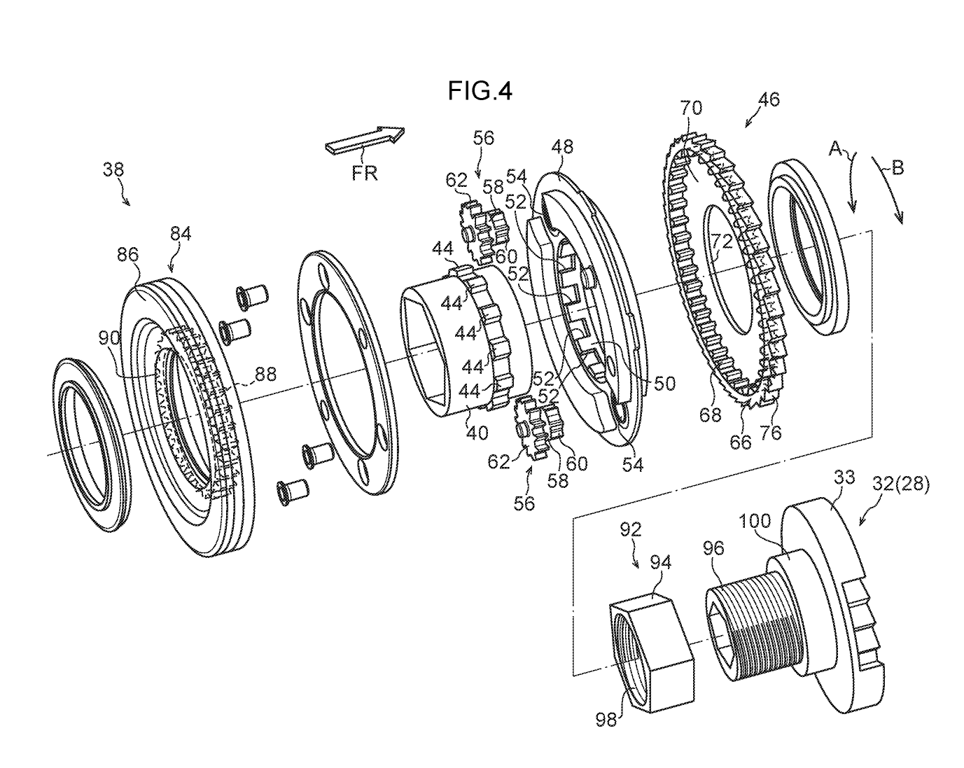

As shown in FIG. 1, a longitudinal direction base end portion of long band-like webbing 22 is anchored to the spool body 20 of the spool 18, and when the spool body 20 is rotated in a take-up direction (the direction of arrow A in FIG. 3 and FIG. 4), the webbing 22 is taken up, from its longitudinal direction base end side, on the spool body 20 of the spool 18. Furthermore, a longitudinal direction distal end side of the webbing 22 extends in the vehicle upward direction from the spool body 20 of the spool 18, and the longitudinal direction distal end side of the webbing 22 passes through a slit hole formed in a through anchor (not shown in the drawings) supported on the center pillar on the vehicle upper side of the frame 12, and turns back in the vehicle downward direction.

Moreover, the longitudinal direction distal end portion of the webbing 22 is anchored to an anchor plate (not shown in the drawings). The anchor plate is made of a metal plate material such as iron and is fixed to, for example, a floor (not shown in the drawings) of the vehicle or a frame member of a seat (not shown in the drawings) corresponding to the webbing take-up device 10.

Furthermore, a seat belt device for the vehicle to which the webbing take-up device 10 has been applied is equipped with a buckle device (not shown in the drawings). The buckle device is provided on the vehicle width direction inner side of the seat to which the webbing take-up device 10 is applied. The webbing 22 becomes applied across the body of an occupant seated in the seat as a result of the occupant pulling the webbing 22 across his/her body and causing a tongue (not shown in the drawings) provided on the webbing 22 to engage with the buckle device.

A shaft portion (not shown in the drawings) is provided, integrally and coaxially with respect to the spool body 20 of the spool 18, on the vehicle rear side of the spool body 20 of the spool 18, and the shaft portion passes through a hole (not shown in the drawings) formed in the leg plate 14 of the frame 12 and extends to the vehicle rear side of the frame 12.

Furthermore, as shown in FIG. 3, a spring housing 24 is provided on the vehicle rear side of the leg plate 14 of the frame 12. A spool urging member (not shown in the drawings) such as a spiral spring is provided on the inside of the spring housing 24. The spool urging member is directly or indirectly engaged with the spool 18 via the shaft portion, and the spool 18 is urged in the take-up direction (the direction of arrow A in FIG. 3 and FIG. 4) by the urging force of the spool urging member.

Moreover, a pretensioner 26 is provided between the leg plate 14 of the frame 12 and the spring housing 24. The pretensioner 26 is activated at the time of a vehicle emergency, and, due to the pretensioner 26 being activated, for example, high-pressure gas is generated inside the pretensioner 26 and the shaft portion is rotated in the take-up direction by the pressure of the high-pressure gas. Due thereto, the spool body 20 of the spool 18 is rotated in the take-up direction (the direction of arrow A in FIG. 3 and FIG. 4) and the webbing 22 is taken up on the spool body 20 of the spool 18.

A lock housing 30 of a lock mechanism 28 is provided on the vehicle front side of the leg plate 16 of the frame 12. As shown in FIG. 1, a lock base 32 serving as a lock rotor is provided on the inside of the lock housing 30. As shown in FIG. 1 and FIG. 4, the lock base 32 includes (is equipped with) a lock base body 33. The lock base body 33 is disposed on the vehicle front side of the spool body 20 of the spool 18. The lock mechanism 28 is activated at the time of a vehicle emergency such as at the time of a vehicle crash, and when the lock mechanism 28 is activated, rotation of the lock base body 33 in a pull-out direction (the direction of arrow B in FIG. 3 and FIG. 4) is limited by a lock member (not shown in the drawings).

Furthermore, as shown in FIG. 1, the webbing take-up device 10 is equipped with a first force limiter mechanism 34 configuring a force limiter, and the first force limiter mechanism 34 is equipped with a torsion bar 36. The torsion bar 36 is formed in a rod shape that is long in the substantially vehicle front and rear direction. The vehicle rear side section of the torsion bar 36 is engaged with the spool body 20 of the spool 18 on the inside of the spool body 20. Due thereto, relative rotation of the spool 18 with respect to the vehicle rear side section of the torsion bar 36 is limited and relative displacement of the spool 18 in the vehicle rearward direction with respect to the torsion bar 36 is limited.

The vehicle front side section of the torsion bar 36 passes through a hole formed in the leg plate 16 of the frame 12, extends to the outside (the vehicle front side) of the frame 12, and is entered in the inside of the lock housing 30 of the lock mechanism 28. The lock base body 33 of the lock base 32 of the lock mechanism 28 is engaged with the vehicle front side section of the torsion bar 36 situated on the inside of the lock housing 30 of the lock mechanism 28. Due thereto, relative rotation of the lock base 32 with respect to the vehicle front side section of the torsion bar 36 is limited and relative displacement of the lock base 32 in the vehicle forward direction with respect to the vehicle front side section of the torsion bar 36 is limited.

For this reason, the lock base body 33 of the lock base 32 of the lock mechanism 28 is connected to the spool body 20 of the spool 18 via the torsion bar 36, and relative rotation of the lock base 32 with respect to the spool 18 is limited. Consequently, when the lock mechanism 28 is activated and rotation of the lock base 32 in the pull-out direction (the direction of arrow B in FIG. 3 and FIG. 4) is limited by the lock member, rotation of the spool body 20 of the spool 18 in the pull-out direction is indirectly limited. Due thereto, pulling-out of the webbing 22 from the spool body 20 of the spool 18 is limited.

As shown in FIG. 3, a second force limiter mechanism 38 configuring the force limiter is provided as a rotational force absorbing mechanism between the spool body 20 of the spool 18 and the leg plate 16 of the frame 12. As shown in FIG. 1 and FIG. 4, the second force limiter mechanism 38 is equipped with a support member 40. The support member 40 is formed in a tubular shape, with the outer peripheral shape of the support member 40 being circular and the inner peripheral shape of the support member 40 being noncircular, such as a polygonal shape (in the present exemplary embodiment, a hexagonal shape) or a spline shape.

As shown in FIG. 1, an attachment portion 42 of the spool 18 is inserted into the vehicle rear side section of the inside of the support member 40 of the second force limiter mechanism 38. The attachment portion 42 of the spool 18 is provided on the vehicle front side of the spool body 20 of the spool 18 and is formed integrally with the spool body 20 and coaxially with respect to the spool body 20. The cross-sectional shape of the attachment portion 42 of the spool 18 is the same as the inner peripheral shape of the support member 40 of the second force limiter mechanism 38, and relative rotation of the support member 40 with respect to the spool 18 is limited. For this reason, the support member 40 is integrally rotated together with the spool 18.

Furthermore, as shown in FIG. 1 and FIG. 4, the support member 40 of the second force limiter mechanism 38 is equipped with plural protrusion portions 44 serving as suppressing portion. The protrusion portions 44 are provided at predetermined intervals therebetween about the central axis of the support member 40 and project from the outer peripheral portion of the support member 40.

Moreover, the second force limiter mechanism 38 is equipped with a rotational force transmitting mechanism 46 configuring a rotational force transmitting section as a speed increasing mechanism that is one aspect of a speed changing mechanism. The rotational force transmitting mechanism 46 is equipped with a carrier plate 48 serving as an input member. The carrier plate 48 is formed in a substantially disc shape, and a through hole 50 is formed in the substantial center of the carrier plate 48. The support member 40 of the second force limiter mechanism 38 is disposed through the through hole 50 in the carrier plate 48.

Furthermore, plural recessed portions 52 are provided in the carrier plate 48. The recessed portions 52 are open at the inner peripheral surface of the through hole 50 in the carrier plate 48. Furthermore, the vehicle rear side ends of the recessed portions 52 are open. Moreover, the positions where the recessed portions 52 are formed about the central axis of the carrier plate 48 correspond to the positions where the plural protrusion portions 44 are formed about the central axis of the support member 40 of the second force limiter mechanism 38.

For this reason, the protrusion portions 44 of the support member 40 can enter into the insides of the recessed portions 52 of the carrier plate 48 as shown in FIG. 1 as a result of the support member 40 being inserted into the through hole 50 in the carrier plate 48 from the vehicle rear side. In a state in which the protrusion portions 44 of the support member 40 have been entered into the insides of the recessed portions 52 of the carrier plate 48, the vehicle front side ends of the protrusion portions 44 of the support member 40 oppose, in the direction of the central axis of the support member 40, the vehicle front side ends of the insides of the recessed portions 52 of the carrier plate 48. For this reason, the vehicle front side ends of the protrusion portions 44 of the support member 40 are brought into abutting contact with the vehicle front side ends of the insides of the recessed portions 52 of the carrier plate 48, and due thereto, further relative movement of the carrier plate 48 in the vehicle rearward direction with respect to the support member 40 is limited.

Furthermore, in a state in which the protrusion portions 44 of the support member 40 have been entered into the insides of the recessed portions 52 of the carrier plate 48, both side ends of each of the protrusion portions 44 of the support member 40 in the circumferential direction of the support member 40 oppose, in the circumferential direction of the support member 40, both side ends of the insides of each of the recessed portions 52 of the carrier plate 48 in the circumferential direction of the carrier plate 48. For this reason, when the support member 40 is rotated in the take-up direction (the direction of arrow A in FIG. 3 and FIG. 4) or the pull-out direction (the direction of arrow B in FIG. 3 and FIG. 4), the carrier plate 48 is rotated together with the support member 40.

Moreover, as shown in FIG. 1 and FIG. 4, a pair of support holes 54 are formed in the carrier plate 48. The support holes 54 penetrate through the carrier plate 48, and one support hole 54 is formed on the opposite side of the other support hole 54 across the through hole 50 in the carrier plate 48. The inner peripheral shape of each of the support holes 54 is circular, and the distance from the center of the through hole 50 to the center of the one support hole 54 in the carrier plate 48 is the same as the distance from the center of the through hole 50 to the center of the other support hole 54 in the carrier plate 48.

Planetary gears 56 serving as first intermediate member are provided in the support holes 54 in the carrier plate 48. Each planetary gear 56 is equipped with a shaft portion 58. Each of the shaft portions 58 of the planetary gears 56 has a rod cylinder shape. The shaft portions 58 of the planetary gears 56 are disposed on the insides of the support holes 54 in the carrier plate 48, and due thereto, the planetary gears 56 are supported in the carrier plate 48 in such a way that they are configured to freely rotate about the shaft portions 58.

Furthermore, a first gear portion 60 is provided on the vehicle front side of the shaft portion 58 of each planetary gear 56, and a second gear portion 62 is provided on the vehicle rear side of the shaft portion 58 of each planetary gear 56. The first gear portion 60 and the second gear portion 62 of each planetary gear 56 are outer-toothed spur gears, with the addendum (gear tip end) circle of each first gear portion 60 being smaller than the outer peripheral shape of the shaft portion 58 of the planetary gear 56 and the addendum (gear tip end) circle of each second gear portion 62 being larger than the outer peripheral shape of the shaft portion 58 of the planetary gear 56. Furthermore, the first gear portions 60 have a fewer number of teeth than the second gear portions 62.

The rotational force transmitting mechanism 46 is equipped with a gear plate 66 serving as a second intermediate member. The gear plate 66 is equipped with an inner-toothed gear portion 68. The inner-toothed gear portion 68 of the gear plate 66 has a ring shape, spur inner teeth are formed on the inner peripheral portion of the inner-toothed gear portion 68, and the outer teeth of the first gear portions 60 of the planetary gears 56 mesh with the inner teeth of the inner-toothed gear portion 68 of the gear plate 66. The vehicle front side end of the inner-toothed gear portion 68 of the gear plate 66 is closed (blocked off) by a plate portion 70.

Furthermore, a plate hole portion 72 is formed in the substantial center of the plate portion 70 of the gear plate 66. The plate hole portion 72 of the gear plate 66 has a substantially circular shape, and the support member 40 is disposed through the plate hole portion 72 of the gear plate 66. Due thereto, the gear plate 66 is configured to freely relatively rotate with respect to the support member 40 and coaxially with respect to the support member 40.

Moreover, a pawl 74 serving as a switching member is provided on the side (the vehicle lower side) of the gear plate 66. The base end side section of the pawl 74 is provided in such a way as to be rotatable (swingable) about an axis whose axial direction coincides with the vehicle front and rear direction, and the pawl 74 is swung as a result of the pretensioner 26 being activated. Furthermore, engagement teeth (not shown in the drawings) are provided on the distal end side section of the pawl 74. Outer teeth 76 are formed on the outer peripheral portion of the gear plate 66 of the rotational force transmitting mechanism 46 in correspondence to the engagement teeth on the distal end side section of the pawl 74. The outer teeth 76 of the gear plate 66 are ratchet teeth, the engagement teeth of the pawl 74 can mesh with the outer teeth 76 of the gear plate 66 as a result of the pawl 74 being swung, and rotation of the gear plate 66 in the pull-out direction (the direction of arrow B in FIG. 3 and FIG. 4) is limited as a result of the engagement teeth of the pawl 74 meshing with the outer teeth 76 of the gear plate 66.

The second force limiter mechanism 38 is equipped with a flywheel 84 serving as a deformation suppressing (controlling) member, and the flywheel 84 is equipped with a flywheel body 86 serving as an inertial mass. The flywheel body 86 of the flywheel 84 is formed in a disc shape, and the thickness direction of the flywheel body 86 is parallel to the vehicle front and rear direction (that is, the direction of the central axis of the spool 18).

The diameter dimension of the flywheel body 86 of the flywheel 84 is, for example, larger than the diameter dimension of the spool body 20 of the spool 18 at a section of the spool body 20 that takes up the webbing 22. Furthermore, the thickness dimension of the flywheel body 86 of the flywheel 84 is, for example, larger than the thickness dimension of the carrier plate 48 and the gear plate 66 of the second force limiter mechanism 38.

A sun gear portion 88 configuring an output member of the rotational force transmitting mechanism 46 is provided on the vehicle front side of the flywheel body 86. The sun gear portion 88 is an outer-toothed spur gear and is formed integrally with respect to the flywheel body 86 and coaxially with respect to the flywheel body 86.

Furthermore, a flywheel hole portion 90 is formed in the flywheel 84 (that is, the flywheel body 86 and the sun gear portion 88) of the second force limiter mechanism 38. The flywheel hole portion 90 is formed in the substantial center of the flywheel 84 and penetrates through the flywheel 84. The support member 40 is disposed through the inside of the flywheel hole portion 90 of the flywheel 84. Due thereto, the flywheel 84 is configured to freely relatively rotate with respect to the support member 40 and coaxially with respect to the support member 40.

The second gear portions 62 of the planetary gears 56 mesh with the sun gear portion 88 of the flywheel 84. That is, the carrier plate 48, the planetary gears 56, the gear plate 66, and the flywheel 84 configure a planetary gear train. Here, the mass of the flywheel 84 is greater than the mass of the gear plate 66, and the rotational force of the planetary gears 56 needed to cause the flywheel 84 to rotate is greater than the rotational force of the planetary gears 56 needed to cause the gear plate 66 to rotate.

For this reason, rotation of the carrier plate 48 is transmitted via the planetary gears 56 to both the sun gear portion 88 of the flywheel 84 and the inner-toothed gear portion 68 of the gear plate 66, and in a state in which rotation of the gear plate 66 is not limited, the gear plate 66 is rotated by the rotation of the carrier plate 48 and rotation of the flywheel 84 is suppressed. In contrast to this, in a state in which rotation of the gear plate 66 is limited, the flywheel 84 is rotated, by the rotation of the carrier plate 48, faster than the carrier plate 48 in the same direction as the rotational direction of the carrier plate 48.

The webbing take-up device 10 is equipped with a force limiter stopper mechanism 92. The force limiter stopper mechanism 92 is equipped with a stopper 94. The stopper 94 is disposed on the vehicle front side of the attachment portion 42 of the spool 18 on the inside of the support member 40 of the second force limiter mechanism 38. The outer peripheral shape of the stopper 94 is the same (in the present embodiment, a hexagonal shape) as the inner peripheral shape of the support member 40 of the second force limiter mechanism 38, and the outer peripheral surface of the stopper 94 is in abutting contact with the inner peripheral surface of the support member 40. For this reason, when the support member 40 of the second force limiter mechanism 38 is rotated together with the spool 18, the stopper 94 is rotated together with the support member 40.

Furthermore, the force limiter stopper mechanism 92 is equipped with a threaded shaft 96 serving as a guide member. The threaded shaft 96 is formed in a cylinder (tube) shape and is disposed on the inside of the support member 40 of the second force limiter mechanism 38 and coaxially with respect to spool 18. Male threads are formed on the outer peripheral portion of the threaded shaft 96. A female threaded hole 98 is formed in the stopper 94 of the force limiter stopper mechanism 92 in correspondence to the male threads of the threaded shaft 96 of the force limiter stopper mechanism 92. The female threaded hole 98 in the stopper 94 penetrates through the stopper 94 in the vehicle front and rear direction, and female threads are formed in the inner peripheral portion of the female threaded hole 98. The male threads of the threaded shaft 96 of the force limiter stopper mechanism 92 are screwed together with the female threads of the female threaded hole 98 in the stopper 94, and when the stopper 94 is rotated in the pull-out direction (the direction of arrow B in FIG. 3 and FIG. 4) with respect to the threaded shaft 96, the stopper 94 is moved in the vehicle forward direction with respect to the threaded shaft 96.

A stopper abutment portion 100 serving as a movement limiting portion is provided on the vehicle front side of the threaded shaft 96 of the force limiter stopper mechanism 92. The stopper abutment portion 100 is formed in a cylinder (tube) shape. At least the vehicle rear side section of the stopper abutment portion 100 is disposed on the inside of the support member 40 of the second force limiter mechanism 38 and coaxially with respect to the spool 18. A vehicle rear side end of the stopper abutment portion 100 is integrally connected to the threaded shaft 96 of the force limiter stopper mechanism 92, and a vehicle front side end of the stopper abutment portion 100 is integrally connected to the lock base body 33 of the lock base 32. The torsion bar 36 of the first force limiter mechanism 34 is disposed through the inside of the threaded shaft 96 of the force limiter stopper mechanism 92 and through the inside of the stopper abutment portion 100, and the vehicle front side section of the torsion bar 36 is engaged with the lock base body 33 of the lock base 32.

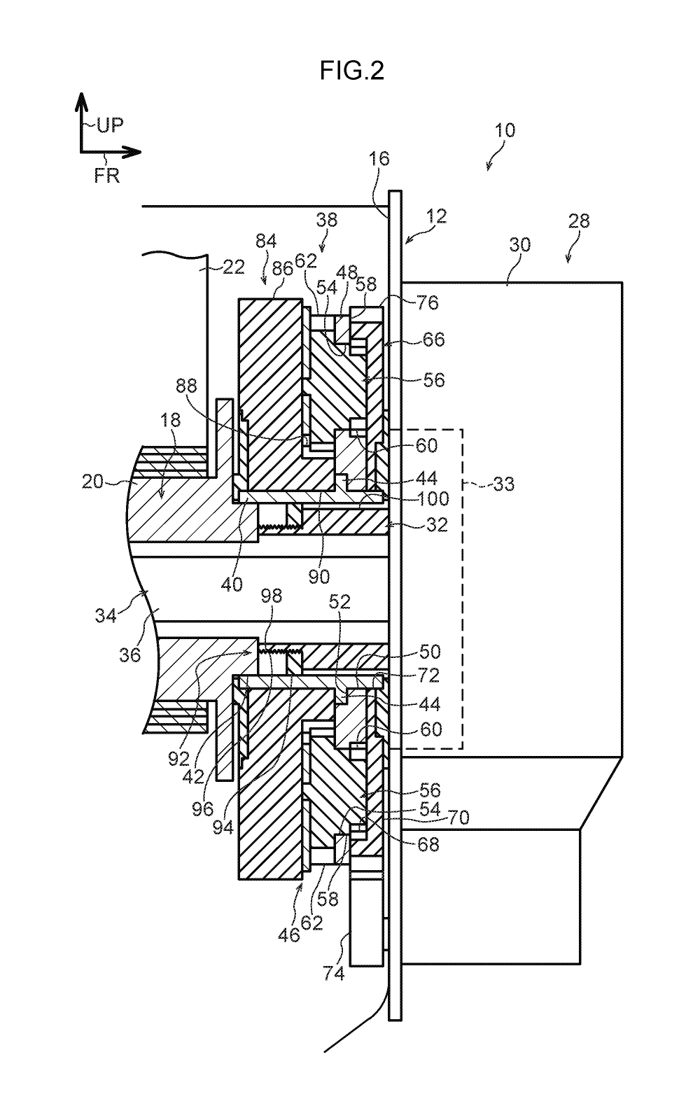

For this reason, when, in a state in which rotation of the lock base 32 in the pull-out direction has been limited, the spool 18 is rotated in the pull-out direction resulting in the stopper 94 of the force limiter stopper mechanism 92 being moved in the vehicle forward direction while being rotated in the pull-out direction, the stopper 94 is moved closer to the stopper abutment portion 100. In this way, when the vehicle front side end of the stopper 94 of the force limiter stopper mechanism 92 is brought into abutting contact with the vehicle rear side end of the stopper abutment portion 100 of the force limiter stopper mechanism 92, movement of the stopper 94 in the vehicle forward direction and rotation of the stopper 94 in the pull-out direction are limited (restricted) (the state shown in FIG. 2).

Furthermore, the outer peripheral shape of the stopper abutment portion 100 of the force limiter stopper mechanism 92 is smaller than the inner peripheral shape of the support member 40 of the second force limiter mechanism 38, and the outer peripheral surface of the stopper abutment portion 100 is not in abutting contact with the inner peripheral surface of the support member 40. For this reason, the support member 40 is relatively rotatable with respect to the stopper abutment portion 100 of the force limiter stopper mechanism 92. Furthermore, the vehicle rear side end of the stopper abutment portion 100 is set in the same position in the vehicle front and rear direction (that is, the direction of the central axis of the spool 18) as the vehicle front side end of the flywheel body 86 of the flywheel 84 of the second force limiter mechanism 38. For this reason, in a state in which the vehicle front side end of the stopper 94 of the force limiter stopper mechanism 92 has been brought into abutting contact with the vehicle rear side end of the stopper abutment portion 100, the flywheel body 86 of the flywheel 84 of the second force limiter mechanism 38 is disposed on the radial direction outer side of the stopper 94, with the support member 40 of the second force limiter mechanism 38 being sandwiched in between.

<Operation and Effects of Exemplary Embodiment>

In the webbing take-up device 10, the lock mechanism 28 is activated at the time of a vehicle emergency such as at the time of a vehicle crash. When the lock mechanism 28 is activated, rotation of the lock base 32 of the lock mechanism 28 in the pull-out direction (the direction of arrow B in FIG. 3 and FIG. 4) is limited by the lock member of the lock mechanism 28. The lock base 32 of the lock mechanism 28 is connected to the spool body 20 of the spool 18 via the torsion bar 36 of the first force limiter mechanism 34. For this reason, rotation of the spool 18 in the pull-out direction is limited as a result of rotation of the lock base 32 of the lock mechanism 28 in the pull-out direction being limited. Due thereto, pulling-out of the webbing 22 from the spool body 20 of the spool 18 is limited, so the body of the occupant can be restrained by the webbing 22 and inertial movement of the body of the occupant in the vehicle forward direction can be suppressed.

Furthermore, the pretensioner 26 is activated at the time of a vehicle emergency such as at the time of a vehicle crash. When the pretensioner 26 is activated, the shaft portion (not shown in the drawings) integrally provided on the spool body 20 of the spool 18 is rotated in the take-up direction. Due thereto, the spool body 20 of the spool 18 is rotated in the take-up direction (the direction of arrow A in FIG. 3 and FIG. 4) and the webbing 22 is taken up on the spool body 20 of the spool 18. Due thereto, slack in the webbing 22 fastened across the body of the occupant is eliminated and the body of the occupant is more strongly restrained by the webbing 22. Furthermore, as a result of the pretensioner 26 being activated, the pawl 74 is swung and the engagement teeth of the pawl 74 mesh with the outer teeth 76 of the gear plate 66 of the second force limited mechanism 38. Due thereto, rotation of the gear plate 66 in the pull-out direction (the direction of arrow B in FIG. 3 and FIG. 4) is limited.

When the occupant is going to (try to) move due to inertia in the vehicle forward direction after the pretensioner 26 has been activated in this way, the webbing 22 is pulled by the body of the occupant. Due thereto, rotational force in the pull-out direction (the direction of arrow B in FIG. 3 and FIG. 4) is applied to the spool body 20 of the spool 18. When the magnitude of the rotational force in the pull-out direction applied to the spool body 20 of the spool 18 exceeds a magnitude needed for torsional deformation of the torsion bar 36 of the first force limiter mechanism 34, the spool 18 is rotated in the pull-out direction. Due thereto, the torsion bar 36 becomes torsionally deformed, the webbing 22 is pulled out from the spool body 20 of the spool 18 with an amount corresponding to the amount of rotation of the spool 18, and the occupant is moved due to inertia in the vehicle forward direction. Moreover, some of the rotational force of the spool 18 in the pull-out direction, that is, some of the tension applied from the body of the occupant to the webbing 22, is supplied to the torsional deformation of the torsion bar 36 and is absorbed.

Furthermore, when the spool 18 is rotated in the pull-out direction (the direction of arrow B in FIG. 3 and FIG. 4) in this way, the rotation of the spool 18 in the pull-out direction is transmitted to the carrier plate 48 of the second force limiter mechanism 38 via the support member 40 of the second force limiter mechanism 38. In this state, as described above, rotation of the gear plate 66 in the pull-out direction is limited by the pawl 74. For this reason, in this state, the rotational force transmitting mechanism 46 of the second force limiter mechanism 38 becomes a planetary gear train where the gear plate 66 that is an internal gear is fixed and the rotation that has been input to the carrier plate 48 is increased in speed and transmitted via the planetary gears 56 to the sun gear portion 88 of the flywheel 84. Consequently, the rotational force of the spool 18 in the pull-out direction is increased in speed and transmitted to the sun gear portion 88 of the flywheel 84.

At this time, when the spool 18 is accelerated and rotated in the pull-out direction (the direction of arrow B in FIG. 3 and FIG. 4), the flywheel 84 of the second force limiter mechanism 38 is accelerated and rotated, and inertial force in the opposite direction of the rotational direction acts on the flywheel 84. The inertial force acting on the flywheel 84 is transmitted to the attachment portion 42 of the spool 18 as force resisting the rotation of the spool 18 in the pull-out direction. Consequently, in this state, the spool 18 is rotated in the pull-out direction as a result of the magnitude of the rotational force in the pull-out direction applied to the spool 18 exceeding the sum of the magnitude needed for torsional deformation of the torsion bar 36 of the first force limiter mechanism 34 and the magnitude for countering (resisting) the inertial force acting on the flywheel 84.

Due thereto, the webbing 22 is further pulled out from the spool body 20 of the spool 18 with an amount corresponding to the amount of rotation of the spool 18, and the occupant can move due to inertia in the vehicle forward direction. Moreover, some of the rotational force of the spool 18 in the pull-out direction (the direction of arrow B in FIG. 3 and FIG. 4), that is, some of the tension applied from the body of the occupant to the webbing 22, is supplied to the torsional deformation of the torsion bar 36 of the first force limiter mechanism 34 and the rotational force countering the inertial force of the flywheel 84 of the second force limiter mechanism 38 and is absorbed.

When the spool 18 is rotated in the pull-out direction in a state in which rotation of the lock base 32 of the lock mechanism 28 in the pull-out direction has been limited, the support member 40 of the second force limiter mechanism 38 is rotated in the pull-out direction together with the spool 18, resulting in the stopper 94 of the force limiter stopper mechanism 92 being rotated in the pull-out direction. In this state, rotation of the lock base 32 in the pull-out direction is limited, so the stopper 94 is rotated in the pull-out direction with respect to the threaded shaft 96 of the force limiter stopper mechanism 92. Due thereto, the stopper 94 is moved in the vehicle forward direction while being rotated in the pull-out direction with respect to the threaded shaft 96.

When the stopper 94 of the force limiter stopper mechanism 92 is rotated a predetermined number of times in the pull-out direction, the stopper 94 is brought into abutting contact with the stopper abutment portion 100 of the force limiter stopper mechanism 92 as shown in FIG. 2. The lock base body 33 of the lock base 32 of the lock mechanism 28 with which the stopper abutment portion 100 is integrated is engaged with the vehicle front side section of the torsion bar 36 of the first force limiter mechanism 34, and due thereto, relative displacement in the vehicle forward direction with respect to the vehicle front side section of the torsion bar 36 is limited.

For this reason, movement of the stopper 94 of the force limiter stopper mechanism 92 in the vehicle forward direction is limited as a result of the stopper 94 being brought into abutting contact with the stopper abutment portion 100 of the force limiter stopper mechanism 92. Movement of the stopper 94 in the vehicle forward direction is limited in this way, and so rotation of the stopper 94 in the pull-out direction is limited. Due to rotation of the stopper 94 in the pull-out direction being limited, rotation of the support member 40 of the second force limiter mechanism 38 in the pull-out direction is limited and rotation of the spool 18 in the pull-out direction is limited. Due thereto, the pulling-out of the webbing 22 from the spool 18 is limited and the torsional deformation of the torsion bar 36 is ended.

In the webbing take-up device 10, the vehicle rear side end of the stopper abutment portion 100 of the force limiter stopper mechanism 92 is set in the same position in the vehicle front and rear direction (that is, the direction of the central axis of the spool 18) as the vehicle front side end of the flywheel body 86 of the flywheel 84 of the second force limiter mechanism 38. For this reason, in a state in which the vehicle front side end of the stopper 94 of the force limiter stopper mechanism 92 has been brought into abutting contact with the vehicle rear side end of the stopper abutment portion 100, the flywheel body 86 of the flywheel 84 is disposed on the radial direction outer side of the stopper 94, with the support member 40 of the second force limiter mechanism 38 being sandwiched in between.

The diameter dimension of the flywheel body 86 of the flywheel 84 of the second force limiter mechanism 38 is, for example, larger than the diameter dimension of the spool body 20 of the spool 18 at the section of the spool body 20 that takes up the webbing 22, and the thickness dimension of the flywheel body 86 of the flywheel 84 is, for example, larger than the thickness dimension of the carrier plate 48 and the gear plate 66 of the second force limiter mechanism 38. For this reason, the mass and mechanical strength of the flywheel body 86 of the flywheel 84 are, for example, larger than those of the carrier plate 48 and the gear plate 66.

Here, when the rotational force of the spool 18 in the pull-out direction is transmitted to the stopper 94 of the force limiter stopper mechanism 92 via the support member 40 of the second force limiter mechanism 38 in a state in which movement of the stopper 94 in the vehicle forward direction and rotation of the stopper 94 in the pull-out direction have been limited, a force that causes the female threads of the female threaded hole 98 in the stopper 94 to separate from the male threads of the threaded shaft 96 of the force limiter stopper mechanism 92 outward in the radial direction of the stopper 94 acts on the stopper 94. Due thereto, the stopper 94 is going to (try to) become deformed in such a way that the outer peripheral surface of the stopper 94 becomes displaced outward in the radial direction of the stopper 94. When the stopper 94 is going to (try to) become deformed in this way, the inner peripheral surface of the support member 40 is pressed outward in the radial direction of the stopper 94 by the outer peripheral surface of the stopper 94, and further the support member 40 is going to (try to) become deformed in such a way that the outer peripheral surface of the support member 40 becomes displaced outward in the radial direction of the support member 40.

In this state, the flywheel body 86 of the flywheel 84 of the second force limiter mechanism 38 is disposed, on the radial direction outer side of the support member 40, at the section, where the stopper 94 is disposed, of the support member 40 of the second force limiter mechanism 38. For this reason, the deformation of the support member 40 described above is suppressed (controlled) by the flywheel body 86 of the flywheel 84, and the deformation of the stopper 94 described above is suppressed (controlled) by the flywheel body 86 of the flywheel 84 via the support member 40. For this reason, the female threads of the female threaded hole 98 in the stopper 94 can be suppressed from separating from the male threads of the threaded shaft 96 of the force limiter stopper mechanism 92, further, it is not necessary to provide a special member just for the purpose of suppressing the female threads of the female threaded hole 98 in the stopper 94 from separating from the male threads of the threaded shaft 96 of the force limiter stopper mechanism 92, therefore a low cost is obtained.

Furthermore, the vehicle rear side end of the stopper abutment portion 100 of the force limiter stopper mechanism 92 is set in the same position in the vehicle front and rear direction (that is, the direction of the central axis of the spool 18) as the vehicle front side end of the flywheel body 86 of the flywheel 84 of the second force limiter mechanism 38. For this reason, in a state in which the stopper 94 of the force limiter stopper mechanism 92 has been brought into abutting contact with the stopper abutment portion 100, the vehicle front side end of the stopper 94 is disposed in the same position in the vehicle front and rear direction (that is, the direction of the central axis of the spool 18) as the vehicle front side end of the flywheel body 86 of the flywheel 84. Due thereto, in a state in which the stopper 94 has been brought into abutting contact with the stopper abutment portion 100, the section of the stopper 94, which section is disposed on the inside of the flywheel hole portion 90 of the flywheel body 86 of the flywheel 84, can be increased (made larger). For this reason, the deformation of the stopper 94 described above can be effectively suppressed by the flywheel body 86 of the flywheel 84.

Moreover, when the deformation of the stopper 94 is suppressed by the flywheel body 86 of the flywheel 84 of the second force limiter mechanism 38 as described above, a large load is input from the stopper 94 via the support member 40 to the flywheel body 86. However, the flywheel body 86 of the flywheel 84 is a member provided to absorb, by means of its inertial force, the rotational force of the spool 18, so, in a state in which rotation of the stopper 94 has been limited as a result of the stopper 94 being brought into abutting contact with the stopper abutment portion 100, rotation of the spool 18 in the pull-out direction is limited and the absorption of the rotational force of the spool 18 by the inertial force of the flywheel 84 has already been ended. For this reason, the large load transmitted from the stopper 94 to the flywheel body 84 of the flywheel 84 as described above can be suppressed from affecting the absorption of the rotational force of the spool 18 in the second force limiter mechanism 38.

Furthermore, the stopper 94 and the threaded shaft 96 configuring the force limiter stopper mechanism 92 are disposed coaxially with respect to the support member 40 of the second force limiter mechanism 38 on the inside of the support member 40, so the stopper 94, the threaded shaft 96, and the support member 40 lie on top of each other (are arranged so as to overlap) in a direction orthogonal to the central axis of the spool 18. For this reason, even in a configuration where the webbing take-up device 10 is equipped with the second force limiter mechanism 38 and the force limiter stopper mechanism 92, the webbing take-up device 10 can be suppressed from increasing in size in the direction of the central axis of the spool 18, and installation of the webbing take-up device 10 in a vehicle becomes easy.

In the present exemplary embodiment, the second force limiter mechanism 38 has a configuration where, in a case where the spool 18 is being accelerated and rotated in the pull-out direction, the rotational force of the spool 18 in the pull-out direction is absorbed by the inertial force of the flywheel 84. However, the second force limiter mechanism 38 may also have a configuration that absorbs the rotational force of the spool 18 in the pull-out direction in a state in which the rotation of the spool 18 in the pull-out direction is not being accelerated, such as a state in which there is no change in the rotational speed of the spool 18 in the pull-out direction.

Furthermore, in the present exemplary embodiment, the rotational force transmitting mechanism 46 of the second force limiter mechanism 38 configured to include the flywheel 84 serving as a deformation suppressing member is configured by a planetary gear mechanism. However, the rotational force transmitting mechanism of the second force limiter mechanism configured to include the flywheel 84 serving as a deformation suppressing member may also have a configuration different from a planetary gear mechanism, such as, for example, a gear train configured by outer-toothed spur gears.

Moreover, in the present exemplary embodiment, the flywheel 84 serving as a deformation suppressing member configures the second force limiter mechanism 38 for absorbing, by means of the inertial force of the flywheel 84, the rotational force of the spool 18 in the pull-out direction. However, the deformation suppressing member may also be, for example, a rotating member of a rotation transmitting device for transmitting the rotational force of an output shaft of a motor to the spool 18 or another member; the deformation suppressing member does not have to have a configuration where it absorbs, by means of its inertial force, the rotational force of the spool 18 in the pull-out direction; and the deformation suppressing member may also have a configuration where it does not rotate, so long as the deformation suppressing member has a configuration where it is provided separately from the spool 18 and the lock base 32 of the lock mechanism 28.

Furthermore, in the present exemplary embodiment, the vehicle rear side end of the stopper abutment portion 100 of the force limiter stopper mechanism 92 is set in the same position in the vehicle front and rear direction (that is, the direction of the central axis of the spool 18) as the vehicle front side end of the flywheel body 86 of the flywheel 84 of the second force limiter mechanism 38. However, the vehicle rear side end of the stopper abutment portion 100 of the force limiter stopper mechanism 92 may be offset to the vehicle front side or the vehicle rear side of the vehicle front side end of the flywheel body 86 of the flywheel 84 of the second force limiter mechanism 38.

What is claimed is:

1. A webbing take-up device comprising:
a spool that is rotated in a pull-out direction due to webbing being pulled out therefrom;
a lock rotor whose rotation is limited at a time of a vehicle emergency;
a limiting member that is rotated and also moved in a direction of an axis of rotation due to the spool being rotated in the pull-out direction in a rotation-limited state of the lock rotor, and that limits rotation of the spool in the pull-out direction due to movement of the limiting member in the direction of the axis of rotation being limited; and
a deformation suppressing member that is provided separately from the spool and the lock rotor, and that suppresses, from an outer side of the limiting member in a radial direction of the limiting member, deformation of the limiting member toward the outer side in the radial direction in a state in which movement of the limiting member in the direction of the axis of rotation is limited.

2. The webbing take-up device of claim 1, wherein the deformation suppressing member is rotatable by receiving rotational force.

3. The webbing take-up device of claim 2, wherein the deformation suppressing member is rotatable by rotational force of the spool being transmitted thereto and is configured to absorb, by means of inertial force of the deformation suppressing member, the rotational force of the spool.

4. The webbing take-up device of claim 2, wherein the deformation suppressing member is disposed coaxially with respect to the limiting member, at least part of the limiting member is disposed inside the deformation suppressing member in a state in which movement of the limiting member in the direction of the axis of rotation is limited, and the deformation suppressing member suppresses deformation of the limiting member from the outer side in the radial direction of the limiting member.

5. The webbing take-up device of claim 3, wherein the deformation suppressing member is disposed coaxially with respect to the limiting member, at least part of the limiting member is disposed inside the deformation suppressing member in a state in which movement of the limiting member in the direction of the axis of rotation is limited, and the deformation suppressing member suppresses deformation of the limiting member from the outer side in the radial direction of the limiting member.

6. The webbing take-up device of claim 1, wherein:
a hole portion is formed at the deformation suppressing member at a center portion of the deformation suppressing member, and
at least part of the limiting member is disposed inside the hole portion in a state in which the limiting member abuts the lock rotor.

7. The webbing take-up device of claim 2, wherein:
a hole portion is formed at the deformation suppressing member at a center portion of the deformation suppressing member, and
at least part of the limiting member is disposed inside the hole portion in a state in which the limiting member abuts the lock rotor.

8. The webbing take-up device of claim 5, wherein:
a hole portion is formed at the deformation suppressing member at a center portion of the deformation suppressing member, and
at least the part of the limiting member is disposed inside the hole portion in a state in which the limiting member abuts the lock rotor.
